(19) United States
(12) Patent Application Publication
(10) Pub. No.: US 2011/0176196 A1
(43) Pub. Date: Jul. 21, 2011

(54) METHODS AND DEVICES FOR PRESSURE DETECTION

(75) Inventors: Alok Govil, Santa Clara, CA (US); Manish Kothari, Cupertino, CA (US)

(73) Assignee: QUALCOMM MEMS Technologies, Inc., San Diego, CA (US)

(21) Appl. No.: 12/779,333

(22) Filed: May 13, 2010

Related U.S. Application Data
(60) Provisional application No. 61/295,613, filed on Jan. 15, 2010.

(51) Int. Cl. G02B 26/00; H01J 9/20

(52) U.S. Cl. 359/290; 445/24

(57) ABSTRACT

Methods and devices for detecting pressure applied to a device are described herein. In one embodiment, the device comprises a first layer and a second layer positioned below the first layer. The first layer and the second layer form a cavity. The device further comprises a plurality of display elements disposed in the cavity. The device further comprises a sensor configured to measure the relative movement between the first layer and the second layer. In another embodiment, the device may detect sound waves.

### CROSS REFERENCE TO RELATED APPLICATION

This application claims the benefit of U.S. Provisional Application No. 61/295,613, filed Jan. 15, 2010, the entire content of which is incorporated herein by reference.

### BACKGROUND

1. Field of the Invention

The present disclosure relates generally to pressure detection, and more specifically to pressure detection using a display.

2. Description of Related Technology

Electromechanical systems (EMS) such as microelectromechanical systems (MEMS) include micro mechanical elements, actuators, and electronics. EMS devices are referred to hereinafter as MEMS devices for the sake of convenience. Micromechanical elements may be created using deposition, etching, and or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8 is an isometric view of an exemplary device for detecting pressure.

FIG. 9 is a top view of an exemplary device 800 of FIG. 8.

FIGS. 10A and 10B illustrates cross section of an exemplary device 800 of FIG. 8.

FIG. 11 is a top view of another exemplary device for measuring pressure.

FIGS. 12A and 12B illustrate a cross section of an exemplary device for measuring pressure shown in FIG. 11.

FIG. 13 illustrates a cross section of another exemplary device for measuring pressure.

FIG. 14 is a flowchart of a process of calibrating the device 800 shown in FIGS. 8-12.

FIG. 15 is a flowchart of a process of detecting changes in pressure utilizing a device 800 shown in FIGS. 8-13.

### DETAILED DESCRIPTION

The following detailed description is directed to certain specific embodiments. However, the teachings herein can be applied in a multitude of different ways. In this description, reference is made to the drawings wherein like parts are designated with like numerals throughout. The embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

Methods and devices are described herein related to detecting pressure and/or movement using a display. A display (e.g., a flat panel monitor) may comprise a front glass and a back glass between which display elements are disposed. Force or pressure applied to the front glass may cause the glass to move with respect to the back glass. For example, sound waves may contact the front glass causing it to vibrate or move. The methods and devices described herein may be configured to detect that relative movement and correlate it to changes in pressure applied to the front glass. For example, a display as described herein may be used as a microphone or an accelerometer. The methods and devices described herein are described with respect to displays using interferometric modulators. However, one of ordinary skill in the art will recognize that similar methods and devices may be used with other appropriate display technologies.

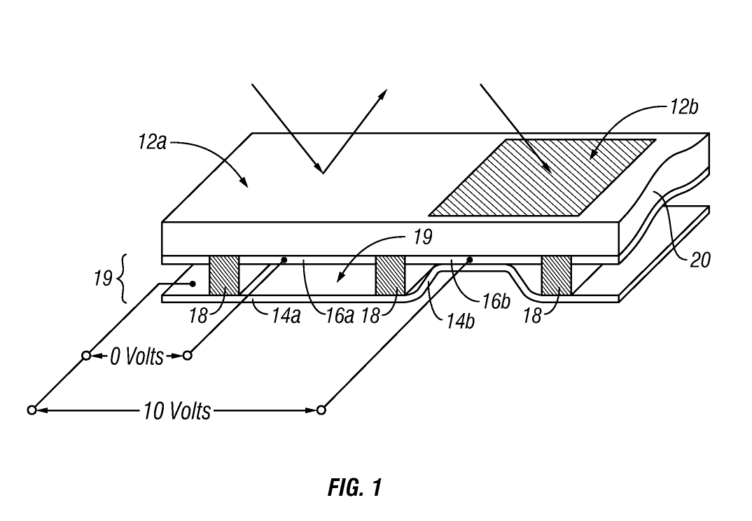

One interferometric modulator display embodiment comprising an interferometric MEMS display element is illustrated in FIG. 1. In these devices, the pixels are in either a bright or dark state. In the bright (“relaxed” or “open”) state, the display element reflects a large portion of incident visible light to a user. When in the dark (“actuated” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) to form columns deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device. Note that FIG. 1 may not be to scale. In some embodiments, the spacing between posts 18 may be on the order of 10-100 um, while the gap 19 may be on the order of <1000 Angstroms.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential (voltage) difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by actuated pixel 12b on the right in FIG. 1. The behavior is the same regardless of the polarity of the applied potential difference.

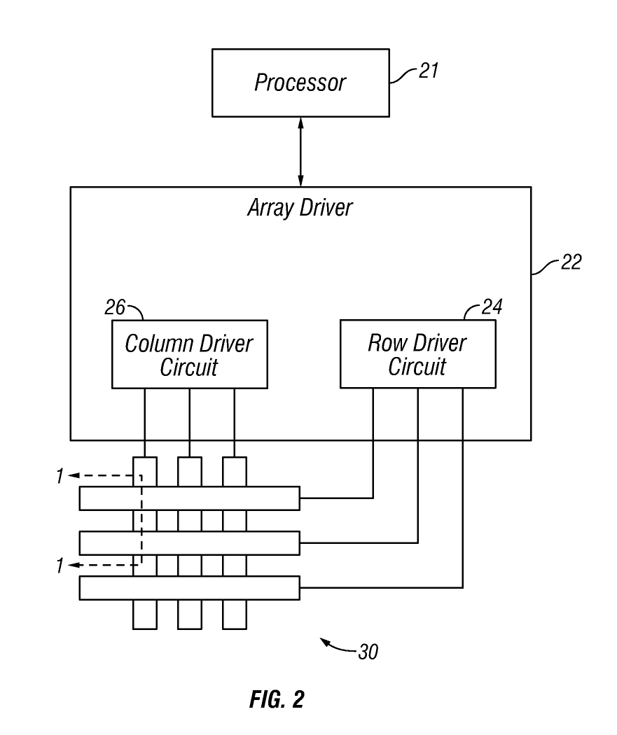

FIGS. 2 through 5 illustrate one exemplary process and system for using an array of interferometric modulators in a display application.

FIG. 2 is a system block diagram illustrating one embodiment of an electronic device that may incorporate interferometric modulators. The electronic device includes a processor 21 which may be any general purpose single- or multi-chip microprocessor such as an ARM®, Pentium®, 8051, MIPS®, Power PC®, or ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column).

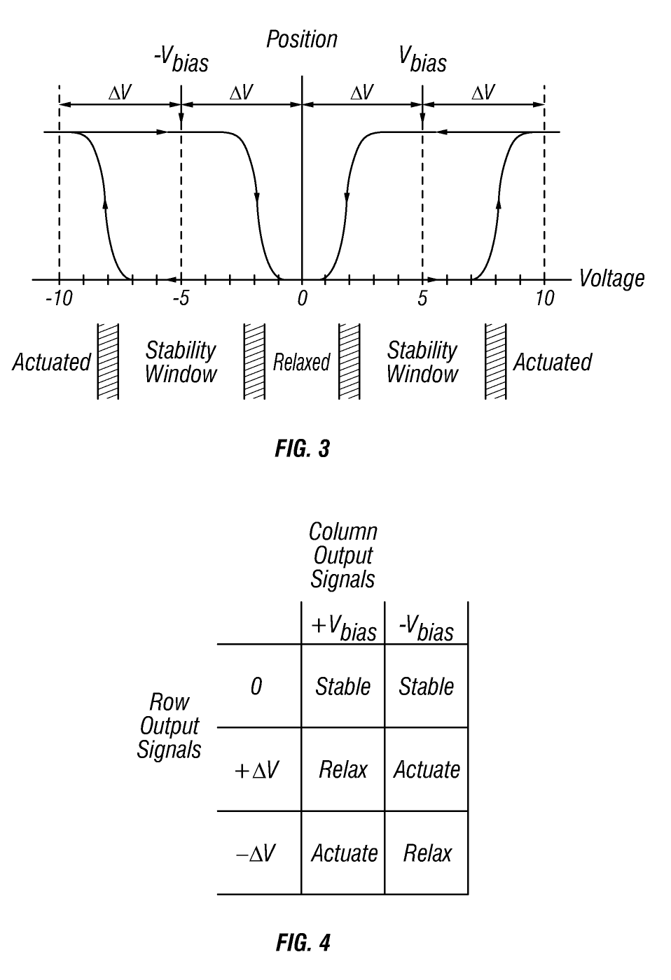

FIG. 3 is a diagram of movable mirror position versus applied voltage for one exemplary embodiment of an interferometric modulator of FIG. 1. For MEMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at ‘some desired number of frames per second. A wide variety of protocols for driving row and column electrodes of pixel arrays to produce image frames may be used.

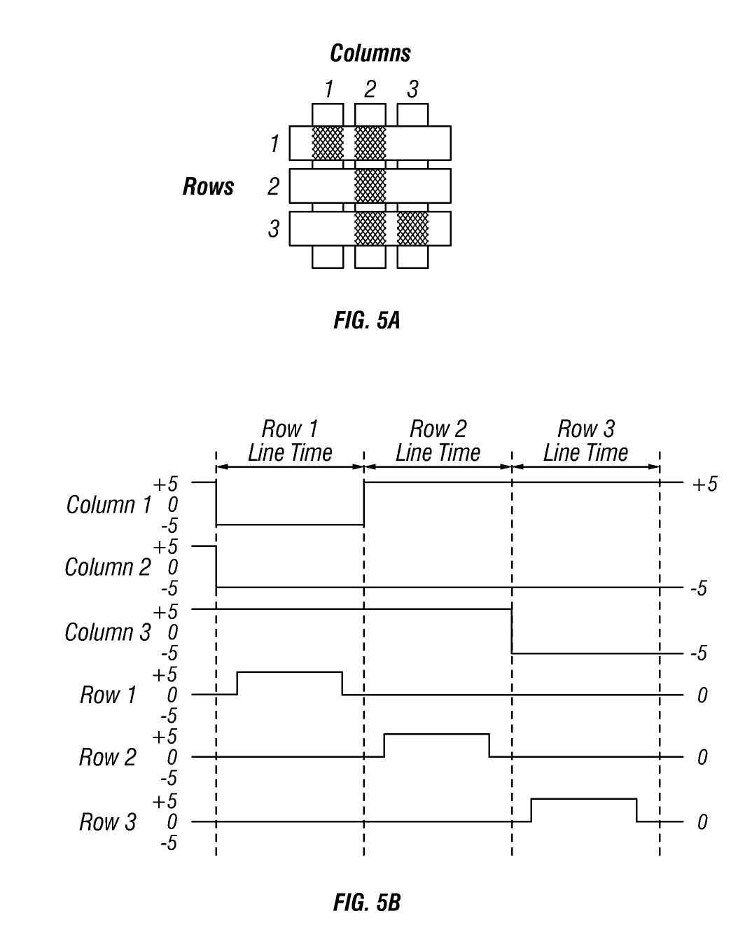

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are initially at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. The same procedure can be employed for arrays of dozens or hundreds of rows and columns. The timing, sequence, and levels of voltages used to perform row and column actuation can be varied widely within the general principles outlined above, and the above example is exemplary only, and any actuation voltage method can be used with the systems and methods described herein.

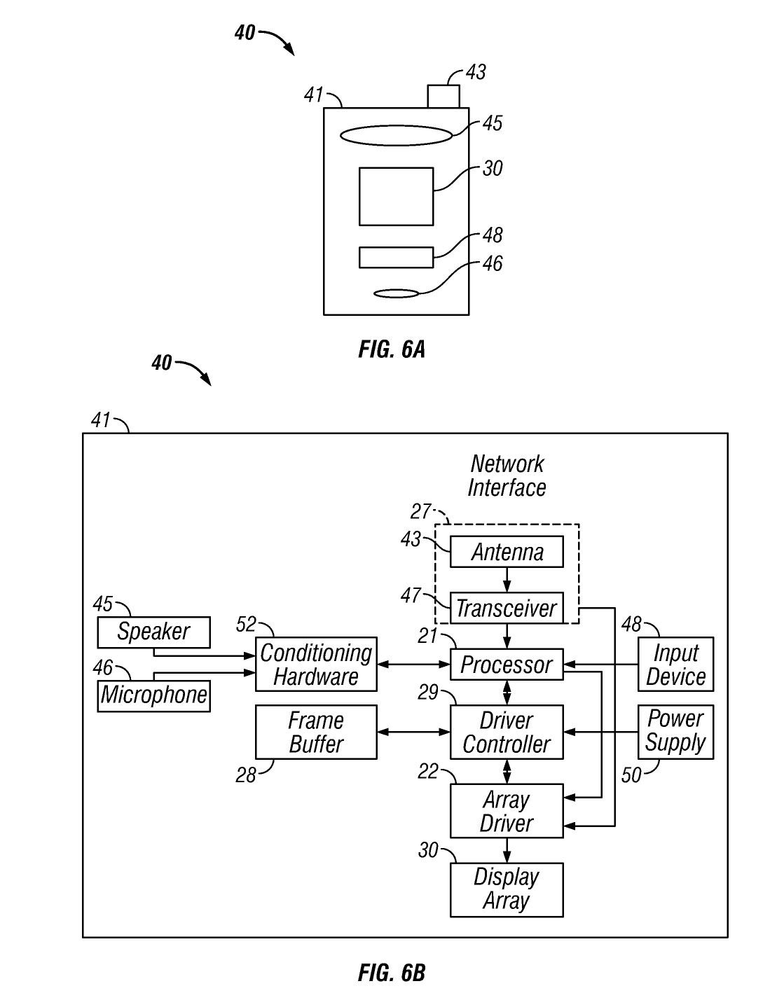

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one ore more devices over a network. In one embodiment the network interface 27 may also have some processing capabilities to relieve requirements of the processor 21. The antenna 43 is any antenna for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. The above-described optimization may be implemented in any number of hardware and/or software components and in various configurations.

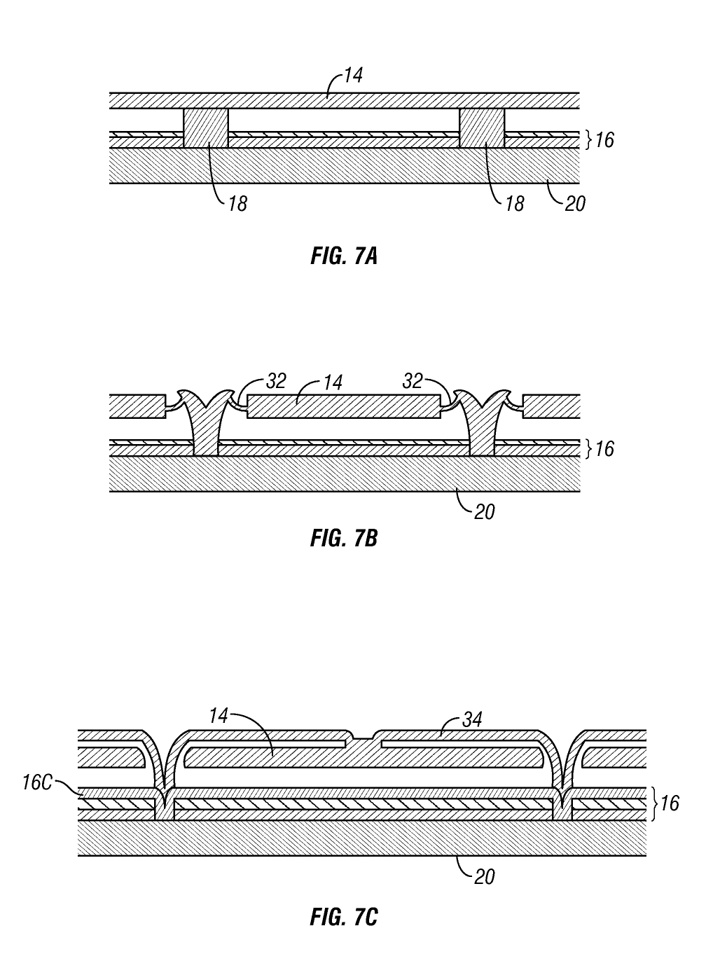

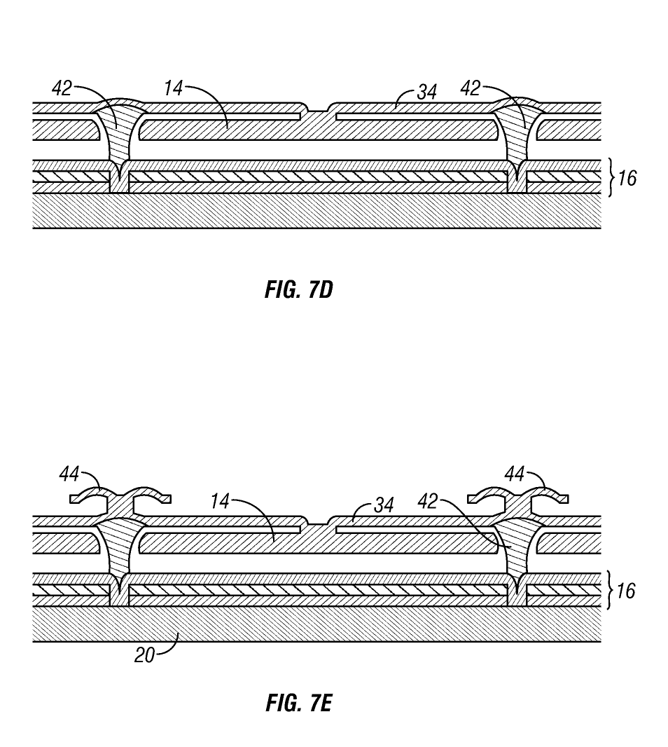

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 of each interferometric modulator is square or rectangular in shape and attached to supports at the corners only, on tethers 32. In FIG. 7C, the moveable reflective layer 14 is square or rectangular in shape and suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D, has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. For example, such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

The devices and methods described herein relate to detecting pressure and/or movement. For example, in one embodiment a device described herein may be used to detect changes in pressure from forces contacting the device. In one embodiment, the contact may correspond to sound waves interacting with the device. Accordingly, the device may be used as a microphone by sensing the force of sound waves hitting a detection surface. In another embodiment, the device may correspond to a display device. The interferometric modulators described above may be used as part of such a display device (e.g., a flat-panel display). Accordingly, the methods and devices described herein may allow for a display device to be used as a microphone. Advantageously, this eliminates the need for additional hardware for the microphone as compared to traditional display devices.

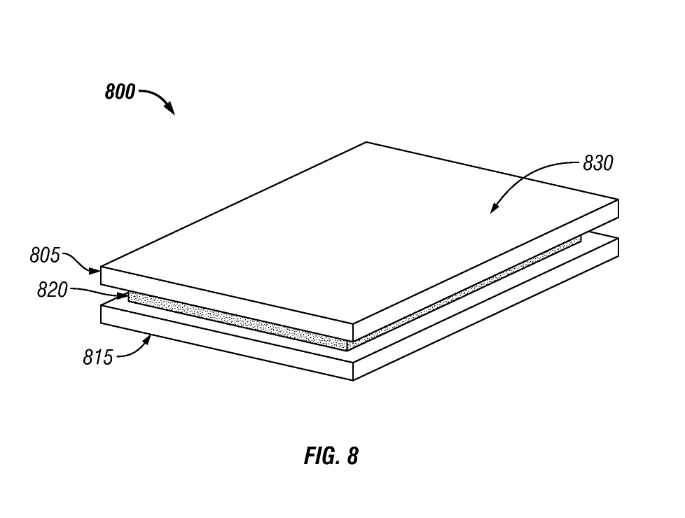

FIG. 8 is an isometric view of an exemplary device for detecting pressure. The device 800 comprises a first layer 805. In one embodiment, the first or front layer 805 comprises a glass layer. The device 800 further comprises a second or back layer 815. It should be noted that the terms “front” and “back” are used only for convenience and should not be construed to spatially limit the positioning of the corresponding layers. In one embodiment, the back layer 815 also comprises a glass layer. The front layer 805 is stacked on top of the back layer 815 as shown. Accordingly, the front layer 805 and the back layer 815 are substantially parallel to each other. The front layer 805 and the back layer 815 are separated by a seal 820 disposed between the front layer 805 and the back layer 815. In one embodiment, the seal runs along an outer periphery of the front layer 805 and the back layer 815. The outer periphery may be the outermost edge of the front layer 805 and the back layer 815. In another embodiment, the outer periphery may be an area between the center of the front layer 805 and the outermost edge of the front layer 805. In another embodiment, the outer periphery may be an area between the center of the back layer 815 and the outermost edge of the back layer 815.

The front layer 805, the back layer 815, and the seal 820 form a cavity 830 and separate the cavity 830 from the environment outside of the device 800. Accordingly, the cavity 830 corresponds to a separate environment inside the device 800 than the environment outside of the device 800. In one embodiment, an array of interferometric modulators may be placed within the cavity 830. Accordingly, the device 800 may be used as a display, wherein the interferometric modulators are used as display elements to display an image. The interferometric modulators may be driven according to the systems and methods described above with respect to FIGS. 1-7. The circuits used to drive the interferometric modulators may be placed within the cavity 830, outside of the cavity 830, or a combination of the two. The circuitry may further be coupled to the interferometric modulators.

The back layer 815 of the device 800 may be fixed. Accordingly, the back layer 815 does not move relative to the other components of the device 800. The front layer 805 may be configured to move relative to the back layer 815. The front layer 805 may be configured to move in response to a pressure difference between the environment outside of the device 800 and the environment inside the cavity 830. The front layer 805 may further be configured to move in response to pressure applied directly to the front layer 805. The amount or degree to which the front layer 805 moves with respect to the back layer 815 may be correlated to the amount of pressure exerted on the device 800.

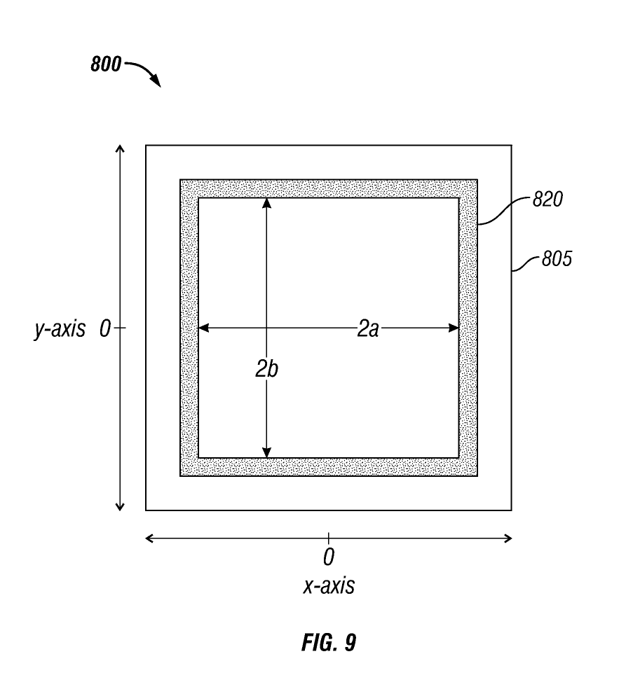

FIG. 9 is a top view of an exemplary device 800 of FIG. 8. The length of the device 800 (and respectively layers 805 and 815) may be measured along a y-axis as shown in FIG. 9. The length of the portion of the first layer 805 that is bounded by the seal 820 as shown is equal to 2*b. Further, the width of the device 800 (and respectively layers 805 and 815) may be measured along an x-axis as shown in FIG. 9. The width of the portion of the first layer 805 that is bounded by the seal 820 as shown is equal to 2*a. The point (0,0) on the x,y plane may correspond to the center of the device 100.

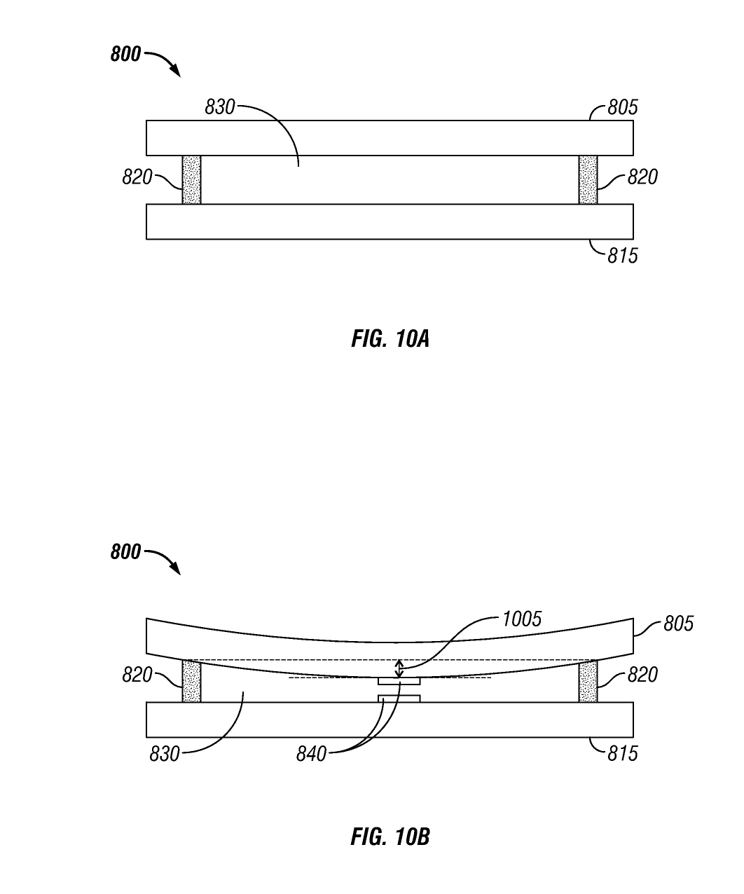

FIGS. 10A and 10B illustrates cross section of an exemplary device 800 of FIG. 8. In FIG. 10A, the device 800 is in an initial state, where the front layer 805 has not been displaced by any outside force. In FIG. 10B, the front layer 805 is shown to be displaced from the initial state. The displacement of the front layer 805 with respect to the initial state may be measured at any point on the front layer 805 and related to the pressure applied to the front layer 805. For example, the displacement at point (0,0) is shown as the distance 1005 in FIG. 10B. Equation 1 below may be used to calculate the applied pressure based on the displacement from the initial position.

$$w ( x , y ) = \frac{p ( 1 - {v}^{2} )}{2 {Eh}^{3}} \frac{{( {a}^{2} - {x}^{2} )}^{2} {( {b}^{2} - {y}^{2} )}^{2}}{{a}^{4} + {b}^{4}} , \qquad ( 1 )$$

where,

w(x,y) is the displacement of the front layer 805 from the initial position;

p is the pressure applied to the front layer 805;

v is Poisson's ratio;

a is half the width of the portion of the front layer 805 within the seal 820;

b is half the length of the portion of the front layer 805 within the seal 820;

x is the distance along the x-axis from the center of the front layer 805 where the displacement w is measured;

y is the distance along the y-axis from the center of the front layer 805 where the displacement w is measured;

E is Young's modulus; and

h is the thickness of the front layer 805 (for glass, E=68 GPa and v=196).

Accordingly, displacement of the front layer 805 can be used to directly calculate the pressure applied to the front layer 805.

Further, the displacement of the front layer 805 may be indirectly calculated by measuring a change in capacitance between the front layer 805 and the back layer 815. For example, the front layer 805 and the back layer 815 may each comprise a conductor 840 placed on the surface of the layer that is exposed to the cavity 830. The conductors may be placed and the capacitance may be measured anywhere within the (x,y) plane of the front layer 805 and the back layer 815. The conductors 840 may further be coupled to a circuit configured to measure the capacitance between the conductors 840. For example, the conductors 840 may be coupled to an integrated circuit (IC) such as the ANALOG DEVICES® IC AD 7747 or the ANALOG DEVICES® IC AD 7746. The (x,y) coordinate of the front layer 805 where the capacitance is measure may be used as the x and y values for Equation 1. The relationship between capacitance and the displacement of the front layer 805 relative to the back layer 815 may be represented by the equation 2 below.

$$\begin{matrix}C = \int {\int }_{ }^{ } \frac{{ɛ}_{0}}{{w}_{0} - w ( x , y )} d x d y \\ = \frac{{C}_{0}}{2 a2b} \int {\int }_{ }^{ } \frac{1}{1 - \frac{w ( x , y )}{{w}_{0}}} d x d y ,\end{matrix} \qquad ( 2 )$$

which can be approximated as:

(C−C₀)/C₀=w(x,y)/w₀,

where,

e₀ is the permittivity of air in the cavity

w(x,y) is the displacement of the front layer 805 from the initial position;

w₀ is the between the front layer 805 and the back layer 815 when in the initial position;

a is half the width of the portion of the front layer 805 within the seal 820;

b is half the length of the portion of the front layer 805 within the seal 820;

C is the measured capacitance after deflection; and

C₀ is the measured capacitance before deflection.

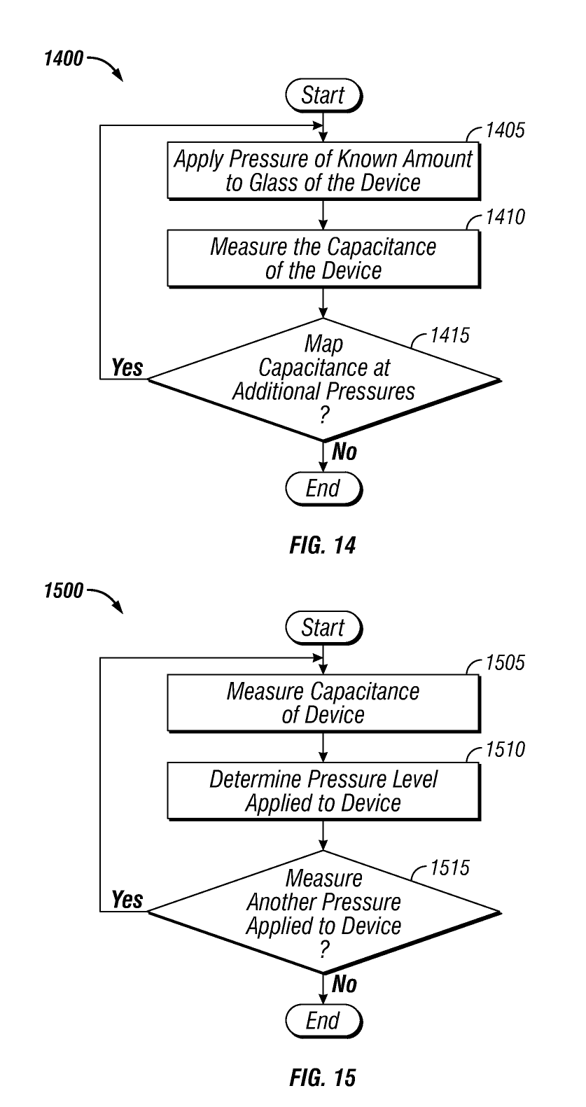

In another embodiment, the relationship between capacitance and displacement of the front layer 805 relative to the back layer 815 may be stored as a set of values in a file or may correspond to another equation that may be generated by the process described below with respect to FIG. 14.

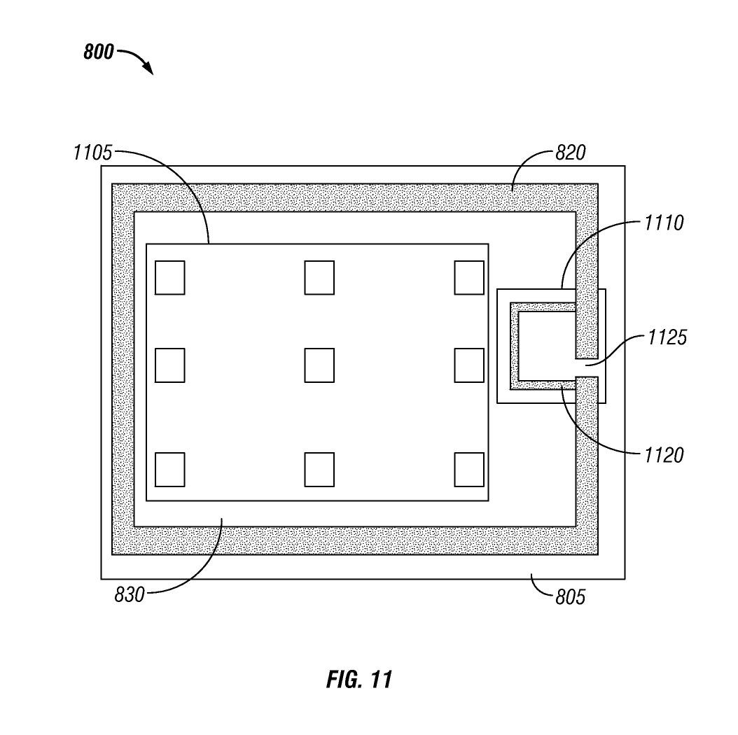

FIG. 11 is a top view of another exemplary device for measuring pressure. In FIG. 11, the device 800 comprises the front layer 805, the back layer 815, and the seal 820 similar to the embodiment shown in FIG. 8. Further, the device 800 comprises interferometric modulators 1105 arranged in an array within the cavity 830. The device 800 further comprises a diaphragm 1110. The diaphragm 1110 may be configured to increase the sensitivity of the device 800 for pressure detection. In one embodiment, the diaphragm 1110 may be placed on the periphery of the device 800 near the seal 820. The diaphragm 1110 may be positioned between the front layer 805 and the back layer 815. In one embodiment, the diaphragm 1110 may be substantially parallel to the front layer 805 and the back layer 815. Further, the seal 820 may be broken at the location of the diaphragm 1110, such that a first surface 1115 of the diaphragm 1110 is exposed to the cavity 830 and a second surface 1120 of the diaphragm 1110 is exposed to the outside environment. For example, at the location of the diaphragm 1110, an air channel 1125 (e.g., a hole) may be formed in the seal 820 between the diaphragm 1110 and one of the front layer 805 and the back layer 815. Further, a second seal 1120 may be placed around the outer periphery of the diaphragm 1110 on the three edges of the diaphragm 1110 other than the edge of the diaphragm 1110 where the seal 820 and air channel 1125 are located. The second seal 1120 may keep the cavity 830 separate from the outside environment even with the air channel 1125 in the seal 820. By exposing one side of the diaphragm 1110 to the cavity 830 and the other side to outside environment, the diaphragm 1110 will move with respect to the pressure difference between the cavity 830 and the outside environment.

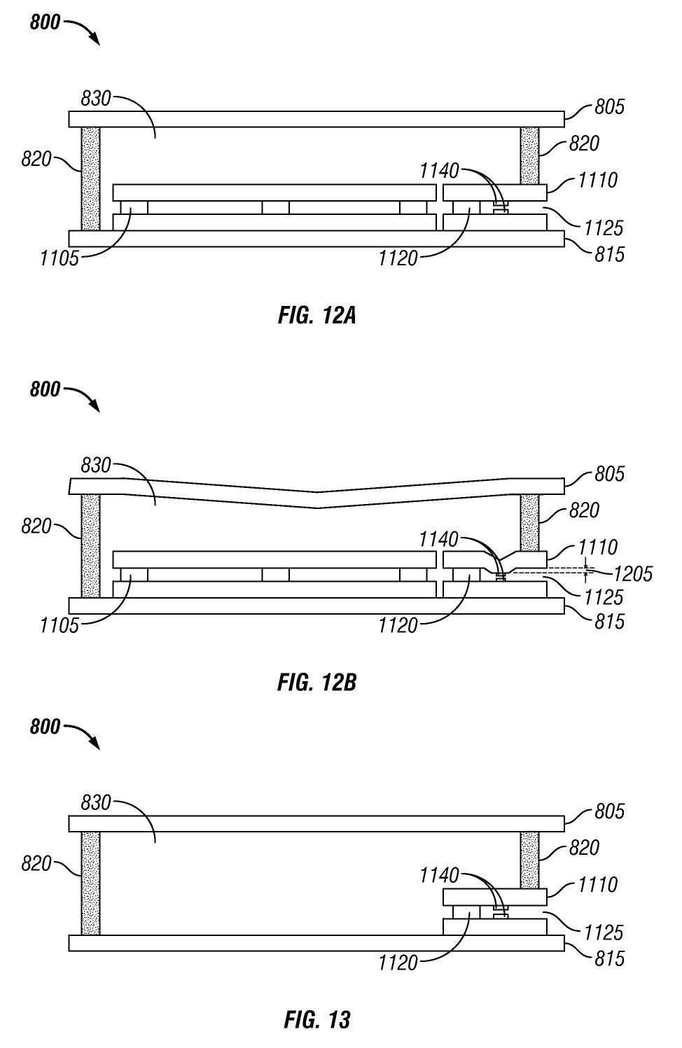

FIGS. 12A and 12B illustrate a cross section of an exemplary device for measuring pressure shown in FIG. 11. As discussed above with respect to FIG. 8, pressure applied to the device 800 causes displacement of the front layer 805 with respect to the back layer 815. Further, the displacement of the front layer 805 causes displacement of the diaphragm 1110. This occurs as the pressure applied to the front layer increases the pressure in the cavity 830. This pressure is exerted on all surfaces exposed to the cavity 830. The diaphragm 1110, which is exposed to the cavity 830, therefore displaces due to the change in pressure. Accordingly, the pressure applied to the front layer 805 may be calculated based on the displacement of the diaphragm 1110. For example, the displacement at point (0,0) is shown as the distance 1205 in FIG. 10B. The applied pressure may be calculated based on the displacement of the diaphragm 1110 from the initial position as discussed below.

Relative movement between the front layer 805 and the back layer 815 changes the pressure inside the cavity 830 in accordance with Boyle's law:

Pᵢₙᵢₜᵢₐₗ=Vᵢₙᵢₜᵢₐₗ=P_{final}*V_{final} (3)

where,

Pᵢₙᵢₜᵢₐₗ is the initial pressure inside the cavity 830 before pressure is applied to the front layer 805;

Vᵢₙᵢₜᵢₐₗ is the initial volume inside the cavity 830 before pressure is applied to the front layer 805;

P_{final} is the final pressure inside the cavity 830 after pressure is applied to the front layer 805; and

V_{final} is the final volume inside the cavity 830 after pressure is applied to the front layer 805.

Accordingly, the change in pressure inside the cavity 830 is due to and equal to the pressure applied to the front layer 805. Further the change in pressure due to the pressure applied to the front layer can be calculated from the displacement of the diaphragm 1110 based on equation 4 below.

$$w ( x , y ) = \frac{p ( 1 - {v}^{2} )}{2 {Eh}^{3}} \frac{{( {a}^{2} - {x}^{2} )}^{2} {( {b}^{2} - {y}^{2} )}^{2}}{{a}^{4} + {b}^{4}} , \qquad ( 4 )$$

w(x,y) is the displacement of the diaphragm 1110 from the initial position;

p is pressure applied to the front layer 805;

v is Poisson's ratio;

a is half the width of the portion of the diaphragm 1110 within the seal 1120;

b is half the length of the portion of the diaphragm 1110 within the seal 1120;

x is the distance along the x-axis from the center of the diaphragm 1110 where the displacement w is measured;

y is the distance along the y-axis from the center of the diaphragm 1110 where the displacement w is measured;

E is Young's modulus; and

h is the thickness of the diaphragm 1110.

Further, the displacement of the diaphragm 1110 may be measured indirectly by determining a change in capacitance between the diaphragm 1110 and the back layer 805. In one embodiment, conductors 1140 may be placed appropriately on the diaphragm 1110 and the back layer 815. The conductors 1140 may further be coupled to a circuit configured to measure the capacitance between the conductors 1140. For example, the conductors 840 may be coupled to an integrated circuit (IC) such as the ANALOG DEVICES® IC AD 7747 or the ANALOG DEVICES® IC AD 7746. The relationship between capacitance and the displacement of the diaphragm 1110 relative to the back layer 815 may be represented by the equation 5 below.

(C−C₀)/C₀=w(x,y)/w₀, (5)

where,

w(x,y) is the displacement of the diaphragm 1110 from the initial position;

w₀ is the between the diaphragm 1110 and the back layer 815 when in the initial position;

C is the measured capacitance after deflection; and

C₀ is the measured capacitance before deflection.

In another embodiment, the relationship between capacitance and displacement of the diaphragm 1110 relative to the back layer 815 may be stored as a set of values in a file or may correspond to another equation that may be generated by the process described below with respect to FIG. 14.

The embodiment of device 800 comprising the diaphragm 1110 may allow for the pressure to measured with greater sensitivity. In one embodiment, the diaphragm is made out of a thinner material than the front layer 805. For example, the diaphragm 1110 may be made out of aluminum, silicon oxynitride (SiON), etc. The displacement of the diaphragm 1110 may be greater than the displacement of the front layer 805 as the material and size of the diaphragm 1110 may cause it to move more than the front layer 805 for the same amount of pressure applied. The greater movement of the diaphragm 1110 corresponds to a greater change in capacitance between the diaphragm 1110 and the back layer 815 as compared to the capacitance change between the front layer 805 and the back layer 815. Further, the diaphragm may be closer to the back layer 805 than the front layer 805. Accordingly, the value of w₀ in equation 5 is smaller than the value of w₀ in equation 2, therefore increasing the change in capacitance between the diaphragm 1110 and the back layer 815. The circuitry used to measure capacitance may have a limited level of precision. For example, the circuit may be configured to only measure capacitance changes on the scale of pF. Therefore, changes in applied pressure may only be detected if there is a corresponding change in capacitance of at least 1 pF. By increasing the change in capacitance for a given change in pressure, therefore, smaller changes in pressure may be detected. For example, in the embodiment described with respect to FIG. 8, a change in pressure of X may correspond to a change in capacitance of less than 1 pF. Accordingly, the embodiment described with respect to FIG. 8 may not be configured to detect a change in pressure of X. However, the same change in pressure of X may cause a capacitance change of greater than 1 pF in the embodiment of FIG. 12. Accordingly, the embodiment of FIG. 12 may be configured to detect a change in pressure of X. One or ordinary skill in the art will recognize that the choice of material, shape, and size for the front layer 805 may be used to change the sensitivity of the device 800. Further, the choice of material, shape, and size for the diaphragm may be used to change the sensitivity of the device 800. In addition, the choice of sensing circuitry for measuring capacitance may be used to change the sensitivity of the device 800.

FIG. 13 illustrates a cross section of another exemplary device for measuring pressure. In FIG. 13, the device 800 is similar to the device 800 of FIGS. 11-12, except that the device 800 in FIG. 13 does not include interferometric modulators 1105 arranged in an array within the cavity 830. Therefore, as would be understood by one of ordinary skill in the art, the device 800 in FIG. 13 functions similarly to other embodiments of the device 800 described herein.

FIG. 14 is a flowchart of a process of calibrating the device 800 shown in FIGS. 8-12. The process 1400 starts at a step. 1405 where a known amount of pressure is applied to the front layer 805 of the device 800. Continuing at a step 1410, the capacitance change between the conductors 840 or 1140 is measured using the appropriate circuitry. Further at a step 1415, the decision is made to measure the capacitance at additional pressures. If additional capacitance levels are to be measured at additional pressures, the process returns to the step 1405. If additional capacitance levels are not to be measured at additional pressures, the process 1400 ends.

The data points measured corresponding to pairs of pressures and capacitances may, in one embodiment, be used to generate a file. Accordingly, the pressure applied to the device 800 at a given time may be determined by looking up the closest capacitance value corresponding to the capacitance of the device 800 at the given time in the file. The pressure may then be estimated as the pressure associated with the closest capacitance value. In another embodiment, the data points may be used to generate an equation based on methods known in the art (e.g., best fit curve) to correlate capacitance to pressure.

FIG. 15 is a flowchart of a process of detecting changes in pressure utilizing a device 800 shown in FIGS. 8-13. Starting at a step 1505, the circuitry for measuring the capacitance of the device 800 measures the capacitance of the device 800. Further, at a step 1510, the device 800 determines the pressure applied to the device 800. In one embodiment, the device 800 uses one or more equations such as equations 1-4 to calculate the pressure applied to the device 800. In another embodiment, the device 800 uses a lookup file to find the pressure corresponding to the measured capacitance. At a next step 1515, the device 800 determines whether to measure the applied pressure again or not. If the device 800 determines to measure applied pressure again, the process returns to the step 1505. If the device 800 determines not to measure applied pressure again, the process 1500 ends.

While the above processes 1400 and 1500 are described in the detailed description as including certain steps and are described in a particular order, it should be recognized that these processes may include additional steps or may omit some of the steps described. Further, each of the steps of the processes does not necessarily need to be performed in the order it is described.

While the above detailed description has shown, described and pointed out novel features of the invention as applied to various embodiments, it will be understood that various omissions, substitutions, and changes in the form and details of the modulator or process illustrated may be made by those skilled in the art without departing from the spirit of the invention. As will be recognized, the present invention may be embodied within a form that does not provide all of the features and benefits set forth herein, as some features may be used or practiced separately from others.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

1. A display comprising:
a first layer;
a second layer, the first layer and the second layer forming a cavity;
a plurality of display elements disposed in the cavity; and
a diaphragm disposed between the first layer and the second layer,
wherein the diaphragm is configured to displace based on relative movement between the first layer and the second layer, and wherein the diaphragm is configured to measure a pressure difference between an internal pressure inside the cavity and an external pressure outside the cavity.

2. The display of claim 1, further comprising a processing circuit configured to measure a capacitance between the diaphragm and the second layer.

3. The display of claim 1, wherein a first surface of the diaphragm is exposed to the cavity and a second surface of the diaphragm is exposed to an environment outside of the cavity.

4. The display of claim 1, wherein the display is configured to detect sound waves.

5. The display of claim 1, wherein the first layer is a glass layer.

6. The display of claim 1, wherein the second layer is a glass layer.

7. A device comprising:
a first layer;
a second layer, the first layer and the second layer forming a cavity; and
a diaphragm disposed between the first layer and the second layer,
wherein the diaphragm is configured to displace based on relative movement between the first layer and the second layer, and wherein the diaphragm is configured to measure a pressure difference between an internal pressure inside the cavity and an external pressure outside the cavity.

8. The device of claim 7, further comprising a processing circuit configured to measure a capacitance between the diaphragm and the second layer.

9. The device of claim 7, wherein a first surface of the diaphragm is exposed to the cavity and a second surface of the diaphragm is exposed to an environment outside of the cavity.

10. The device of claim 7, wherein the device is configured to detect sound waves.

11. The device of claim 7, wherein the first layer is a glass layer.

12. The device of claim 7, wherein the second layer is a glass layer.

13. A display comprising:
a first layer;
a second layer, the first layer and the second layer forming a cavity;
a plurality of display elements disposed in the cavity; and
a sensor configured to measure the relative movement between the first layer and the second layer.

14. The display of claim 13, wherein the sensor is further configured to measure a capacitance between the first layer and the second layer.

15. The display of claim 14, wherein the sensor is further configured to measure a capacitance between a central portion of the first layer and a central portion of the second layer.

16. The display of claim 13, wherein the display is configured to detect sound waves.

17. The display of claim 13, wherein the first layer is a glass layer.

18. The display of claim 13, wherein the second layer is a glass layer.

19. A method of manufacturing a display, the method comprising:
providing a first layer;
providing a second layer, the first layer and the second layer forming a cavity;
providing a plurality of display elements disposed in the cavity; and
providing a diaphragm disposed between the first layer and the second layer,
wherein the diaphragm is configured to displace based on relative movement between the first layer and the second layer, and wherein the diaphragm is configured to measure a pressure difference between an internal pressure inside the cavity and an external pressure outside the cavity.

20. The method of claim 19, further comprising providing a processing circuit configured to measure a capacitance between the diaphragm and the second layer.

21. The method of claim 19, wherein a first surface of the diaphragm is exposed to the cavity and a second surface of the diaphragm is exposed to an environment outside of the cavity.

22. The method of claim 19, wherein the display is configured to detect sound waves.

23. A method of manufacturing a device, the method comprising:
providing a first layer;
providing a second layer, the first layer and the second layer forming a cavity; and
providing a diaphragm disposed between the first layer and the second layer,
wherein the diaphragm is configured to displace based on relative movement between the first layer and the second layer, and wherein the diaphragm is configured to measure a pressure difference between an internal pressure inside the cavity and an external pressure outside the cavity.

24. The method of claim 23, further comprising providing a processing circuit configured to measure a capacitance between the diaphragm and the second layer.

25. The method of claim 23, wherein a first surface of the diaphragm is exposed to the cavity and a second surface of the diaphragm is exposed to an environment outside of the cavity.

26. The method of claim 23, wherein the device is configured to detect sound waves.

27. A method of manufacturing a display, the method comprising:
providing a first layer;
providing a second layer, the first layer and the second layer forming a cavity;
providing a plurality of display elements disposed in the cavity; and
providing a sensor configured to measure the relative movement between the first layer and the second layer.

28. The method of claim 27, wherein the sensor is further configured to measure a capacitance between the first layer and the second layer.

29. The method of claim 28, wherein the sensor is further configured to measure a capacitance between a central portion of the first layer and a central portion of the second layer.

30. The method of claim 27, wherein the display is configured to detect sound waves.

31. The method of claim 27, wherein the first layer is a glass layer.

32. The method of claim 27, wherein the second layer is a glass layer.

33. A display comprising:
a first layer;
a second layer, the first layer and the second layer forming a cavity;
means for displaying disposed in the cavity; and
means for displacing disposed between the first layer and the second layer,
wherein the displacing means is configured to displace based on relative movement between the first layer and the second layer, and wherein the displacing means is configured to measure a pressure difference between an internal pressure inside the cavity and an external pressure outside the cavity.

34. The display of claim 33, further comprising means for measuring a capacitance between the displacing means and the second layer.

35. The display of claim 33, wherein a first surface of the displacing means is exposed to the cavity and a second surface of the displacing means is exposed to an environment outside of the cavity.

36. The display of claim 33, wherein the display is configured to detect sound waves.

37. A device comprising:
a first layer;
a second layer, the first layer and the second layer forming a cavity; and
means for displacing disposed between the first layer and the second layer,
wherein the displacing means is configured to displace based on relative movement between the first layer and the second layer, and wherein the displacing means is configured to measure a pressure difference between an internal pressure inside the cavity and an external pressure outside the cavity.

38. The device of claim 37, further comprising means for measuring a capacitance between the displacing means and the second layer.

39. The device of claim 37, wherein a first surface of the displacing means is exposed to the cavity and a second surface of the displacing means is exposed to an environment outside of the cavity.

40. The device of claim 37, wherein the device is configured to detect sound waves.

41. A display comprising:
a first layer;
a second layer, the first layer and the second layer forming a cavity;
means for displaying disposed in the cavity; and
means for measuring the relative movement between the first layer and the second layer.

42. The display of claim 41, wherein the measuring means is further configured to measure a capacitance between the first layer and the second layer.

43. The display of claim 42, wherein the measuring means is further configured to measure a capacitance between a central portion of the first layer and a central portion of the second layer.

44. The display of claim 41, wherein the display is configured to detect sound waves.

45. The display of claim 41, wherein the first layer is a glass layer.

46. The display of claim 41, wherein the second layer is a glass layer.
